(19) United States
(12) Patent Application Publication
(10) Pub. No.: US 2015/0328620 A1
(43) Pub. Date: Nov. 19, 2015

(54) METHOD OF CAPTURING HEAVY METALS BY A CHEMICALLY FUNCTIONALIZED SURFACE

(71) Applicant: Surface Innovations Limited, Milton Park, Abingdon, Oxfordshire (GB)

(72) Inventors: Thomas J. WOOD, Abingdon (GB); Jas Pal Singh BADYAL, Wolsingham (GB)

(73) Assignee: SURFACE INNOVATIONS LIMITED, Milton Park, Abington, Oxfordshire (GB)

(21) Appl. No.: 14/759,218

(22) PCT Filed: Jan. 9, 2014
(86) PCT No.: PCT/GB2014/050046

§ 371 Date: Jul. 3, 2015

(30) Foreign Application Priority Data
Jan. 10, 2013 (GB) 1300409.8

(51) Int. Cl. B01J 20/22; C02F 1/28; B01J 20/30

(52) U.S. Cl. CPC B01J 20/22; B01J 20/3085; C02F 1/285; C02F 1/288; C02F 2101/20

(57) ABSTRACT

There is described a method for heavymetal capture, which method comprises the step of bringing the heavy metal into contact with a chemically functionalized surface prepared by a plasma process, the surface being provided with organic functional groups able to coordinate with and thereby capture the heavy metal.

### FIELD OF THE INVENTION

This invention relates to methods for heavy metal capture using chemically functionalized surfaces, methods for producing the chemically functionalized surfaces and chemically functionalized surfaces that may be used in such methods.

### BACKGROUND OF THE INVENTION

There is cause for concern about the levels of heavy metals that have been introduced by humans into the environment. The levels have increased over time due to the increased number of uses of heavy metals. Heavy metals are used in many large-scale industrial processes, cadmium for example is used in the manufacture of batteries, pigments, and plastic stabilizers. Heavy metals are also used in or arise as a by-product of the purification of metals, e.g., the smelting of copper, and in the preparation of nuclear fuels. The high degree of heavy metal pollution has led to increased interest in finding methods for their removal from the environment or at least a reduction in the level of environmental heavy metals. The presence of high levels of many heavy metals is undesirable for human, animal or plant life or to the environment. For example some heavy metals (e.g. mercury, cadmium, lead, chromium) are toxic to many organisms, some can cause corrosion (e.g. zinc, lead), some are harmful in other ways (e.g. arsenic may pollute catalysts). Cadmium amongst others is carcinogenic and leads to multiple toxic effects for humans. As a consequence, the presence of toxic heavy metals including cadmium in drinking water supplies (from either natural or industrial sources) is highly undesirable and therefore safe levels for consumption of those heavy metals including cadmium have been set in the low parts per billion range.

Previous methods for heavy metal removal, such as cadmium removal, e.g. from industrial waste waters, have included use of biopolymers such as polypeptides, starch, chitin, and chitosan, bacteria, algae, fungi, food waste, metal oxides, ion-exchange materials, activated carbon, or electrolysis. All of these conventional methods suffer from a lack of specificity and non-recyclability, they are also expensive to implement or require an intensive power to implement and they are also often impractical for industrial level scale-up.

U.S. Pat. No. 6,156,075 discloses a metal chelate forming group of formula (I) which is attached to the surface of a fibre through either chemical reaction or graft polymerisation (both multiple step procedures) so that the fibre can be of use in heavy metal capture. The group of formula (I) contains a nitrogen atom and EDTA, NTA and DTPA derivatives are given as examples.

U.S. Pat. No. 6,139,742 discloses the use of a membrane for metal ion entrapment, which membrane is provided with chemically activated groups by a multiple step process that involves first selectively hydrolysing the membrane to de-acetylate the surface to expose hydroxyl groups, followed by oxidizing the surface to form aldehyde groups and then attaching a polyamino acid to the aldehyde groups. The method of ion entrapment of this document is not reversible.

U.S. Pat. No. 6,436,481 discloses methods of preparing functionalised substrates having a polymer coating carrying reactive groups on its surface, which coating is formed by after-glow plasma-induced polymerisation. The substrates so coated are disclosed for use in biomedical articles, such as ophthalmic devices, in particular contact lenses, for which the coating undergoes an addition reaction with a biological compound, so as to form a final permanent (non-reversible) coating on the substrate.

There is a need for methods of heavy metal capture that overcome or mitigate the disadvantages of known heavy metal capture and that utilise functional surfaces that are quick and easy to manufacture, in solvent-less, one-step production methods, and which are easily regenerated to allow for subsequent further use in heavy metal capture, are specific, inexpensive to manufacture and/or implement, do not require intensive power to manufacture and/or implement and are easily capable of industrial level scale-up.

It is an aim of the present invention to provide alternative methods for heavy metal capture or removal, which methods overcome or mitigate the problems associated with the previously known methods.

### STATEMENTS OF THE INVENTION

According to a first aspect of the present invention there is provided a method for heavy metal capture, which method comprises the step of bringing the heavy metal into contact with a chemically functionalized surface prepared by a plasma process, the surface being provided with organic functional groups able to coordinate with and thereby capture the heavy metal.

The heavy metal is preferably brought into contact with the chemically functionalized surface in the form of a heavy metal ion. The heavy metal is, therefore, preferably brought into contact with the chemically functionalized surface in a solvent, such as water. The heavy metal may be brought into contact with the chemically functionalized surface in an aqueous solution. Where the heavy metal is cadmium or Zinc it is preferred that it is brought into contact as the Cd²⁺ ion or Zn²⁺ ion.

The duration of contact between the chemically functionalized surface and the heavy metal will vary depending on the nature of the heavy metal and of the chemically functionalized surface. The duration of contact may be in the range of 0.1 seconds to 24 hours. Lower rates of duration will occur if contact takes place under flow, for example if the chemically functionalized surface is provided on a filter through which the heavy metal is passed. In most cases duration of contact will be greater than 30 minutes but less than 20 hours e,g, within the range 0.5 to 20 hours, e.g. 1 to 15 hours. In some cases it has been found that the strength of the bond by which the functional groups coordinates with the heavy metal increases during the period of contact. In general the rate of capture of the heavy metal, e.g. the rate of metal absorption, will begin to slow down during contact and the skilled man will be able to determine a suitable length of contact. In some cases 35 to 65%, e.g. approximately 50%, of the heavy metal has been captured during the first hour of contact, e.g. after approximately 40 minutes. After 15 to 25 hours of contact the rate of capture is within a ppb range. Once captured, the heavy metal could be kept in contact with the chemically functionalized surface for as long as is required, e.g. for transportation purposes.

The heavy metal may be any heavy metal capable of coordinating with the functional groups of the chemically functionalized surface. The term heavy metal includes transition metals, some metalloids, such as arsenic and polonium, lanthanides and actinides. An alternative term for heavy metal is toxic metal. Examples of suitable heavy elements for use in the methods of the present invention are cadmium, zinc, aluminium, arsenic, cobalt, chromium, copper, iron, mercury, manganese, molybdenum, nickel, lead, plutonium, tin, thallium, tungsten thorium, uranium and vanadium. The present invention is particularly suited to the capture of cadmium and zinc and most particularly of cadmium.

The chemically functionalized surface may be made from or provided on any suitable substrate or material. It may be adapted in form or shape to suit the method of use. Suitable materials will be well known to the skilled person and include silicon substrates or materials and porous or non-porous, woven or non-woven substrates or materials, such as non-woven polypropylene cloth. Membranes, such as those used in ultrafiltration techniques, are also suitable, including those formed from poly(sulfone)s.

The chemically functionalized surface is provided with organic functional groups able to coordinate with the heavy metal. The functional groups preferably include organic compounds or groups derived from organic compounds. The functional groups may be able to form organometallic compounds or organometallic bonds or coordination complexes or compounds or coordination bonds with the heavy metal or heavy metal ion, e.g with a Cd²⁻ ion or Zn²⁺ ion. Organometallic bonds are formed between a metal and a carbon atom whereas coordination bonds are formed via a heteroatom such as nitrogen, sulphur or oxygen. Particularly preferred are functional groups that form coordination bonds with the heavy metal via a sulphur or more particularly an oxygen atom.

The functional group preferably coordinates with the heavy metal in a reversible way. The method of the present invention may include the further step of removing the heavy metal captured from the chemically functionalized surface. The removal of the captured heavy metal is preferably effected by contacting the chemically functionalized surface with a medium in which the coordination of the functional groups and the heavy metal is undone or reversed. In a preferred embodiment the chemically functionalized surface is contacted with a reversing agent, such as a weak acid solution, in order to reverse the heavy metal capture, e.g. to break the coordination bonds. Other suitable reversing agents include strong acid, weak alkali, and strong alkali. It is advantageous for the reversal step to involve the simple replacement of the heavy metal or heavy metal ion, such as a Cd²⁺ ion or Zn²⁺ ion, with a hydrogen ion, H⁺. The step of removing the heavy metal may be carried out more than once, i.e. repeatedly. By reversing the heavy metal capture the chemically functionalized surface is regenerated and may be used for further capture of heavy metal. The surface is thereby recyclable and the method can be repeated over and over with the same surface. By containing a removal step the method of the present invention allows for self-regeneration.

The duration of contact between the substrate holding the captured heavy metal and the reversing agent will vary depending on the nature of the heavy metal and of the reversing agent and the chemically functionalized surface. The duration of contact may be in the range of 0.1 seconds to 24 hours. Lower rates of duration will occur if contact takes place under flow, for example if the chemically functionalized surface is provided on a filter through which the reversing agent is passed as the released heavy metal or heavy metal ions released would be immediately removed. A flowing regeneration process may, therefore, be advantageous. In most cases duration of contact will be greater than 30 minutes but less than 20 hours, e,g, within the range 0.5 to 20 hours, e.g. 1 to 15 hours. In general the rate of release of the heavy metal will begin to slow down during contact with the releasing agent and the skilled man will be able to determine a suitable length of contact. The duration of contact required may be dependent on the strength of the releasing agent, e.g. acid, and on the use and degree of agitation (stirring).

The functional groups may take the form of precursor functional groups that are converted under the conditions in which the method takes place to functional groups able to coordinate with the heavy metal, e.g. they are converted to the required functional groups during the step of contact with the heavy metal. The chemically functionalized surface may be provided with precursor functional groups, which in aqueous solution hydrolyse to functional groups able to coordinate with the heavy metal ions in the aqueous solution.

The chemically functionalized surface is preferably provided with a high density of functional groups. When the functional groups are provided on or form part of an organic polymer, the density of the functional groups may be calculated in terms of the number of functional groups per carbon atom of polymer. In such cases the density of functional groups may be in the range of 0.005 to 1 functional groups per carbon of polymer, e.g in the range of 0.01 to 0.5 functional groups, e.g. carboxylic acid groups, per carbon of polymer. The density of functional groups may be measured using X-ray photoelectron spectroscopy (XPS).

The chemically functionalized surface may be provided with one or more type of functional groups.

Each of the functional groups may take any suitable form. Each of the functional groups may be any chemical entity comprising a functional component able to coordinate with the heavy metal. The functional groups may be provided on or form part of an organic polymer. The chemically functionalized surface may for example be an organic polymer provided with one or more functional groups selected from hydroxyl, carboxylic acid, anhydride, epoxide, furfuryl, amine, cyano, halide, trifluoromethyl and thiol groups or groups that include or can be derived from alkenes, alkynes, alkyls, phosphines or hydrides. Suitable functional groups also include heteroaryl groups, i.e. heteroaromatics.

It is preferred that the chemically functionalized surface be provided with active acyl groups or precursors to active acyl groups. The chemically functionalized surface may, therefore, be provided with one or more anhydride functional groups. Anhydrides have two acyl groups attached to the same oxygen atom, where the acyl groups may be the same or different. Acyl anhydrides are a source of reactive acyl groups. Carboxylic anhydrides are particularly preferred. One or more of the oxygen atoms of an anhydride may be replaced by a sulphur atom and such functional groups such as thio anhydrides are included in the present invention. Particularly preferred anhydrides are acetic and maleic anhydride, more particularly preferred is maleic anhydride and derivatives thereof such as (trifluoromethyl) maleic anhydride.

In one embodiment of the present invention, the functional groups are part of a functional entity, for example a polymer, for example a poly(anhydride) or derivatives thereof. The polymer, e.g. the poly(anhydride), may be any suitable polymer, e.g. any suitable poly(anhydride). Where the polymer is a poly(anhydride) it is suitably formed from units of any suitable anhydrides or mixtures of units with other polymers including copolymers of other anhydrides. It is preferred that the poly(anhydride) be formed from units of acetic anhydride or maleic anhydride and their derivatives or mixtures thereof. In one embodiment the polymer is a poly anhydride, in particular a poly (maleic anhydride), e.g. poly((trifluoromethyl)maleic anhydride). In another embodiment the polymer is an anhydride copolymers, e.g. poly(maleic anhydride-co-styrene).

In a preferred embodiment the functionalized surface is prepared from a maleic anhydride precursor. Plasma deposition of such a precursor produces a functionalized surface containing a high density of carboxylic anhydride functional groups that are especially advantageous in heavy metal capture.

It is advantageous for the chemically functionalized surface to be provided with a layer of the functional groups. The layer of functional groups may be a thin layer such as a monolayer, a nanolayer or nanocoating. The functional groups or functional entity may be applied to the surface in a layer having a thickness of for example 1 nm or greater. The layer may have a thickness of up to 500 nm, or of up to 250 or from 50 to 150 nm, e.g. of approximately 100 nm.

The chemically functionalized surface may be prepared by any suitable plasma process so that the functional groups are applied to or deposited on the surface by any known plasma technique. The functional groups are or the functional entity is preferably applied to the surface by plasma deposition of an organic polymer. The use of plasma processing is advantageous as it allows the surface to be prepared using a single-step process, which process can be solvent-less and which is fast compared to other methods of functionalized surface preparation. It also allows for the preparation of a surface having a suitable density of functional groups such that it is able to carry out heavy metal capture with suitable efficiency.

In a preferred embodiment, preparation of the chemically functionalized surface involves depositing a suitable material onto the substrate using a direct, non-remote, plasma deposition technique.

In a direct plasma deposition process the functional groups are applied to a substrate in the direct presence of a plasma (the exciting medium). This is an in-glow as opposed to an after-glow plasma technique. In a remote, after-glow, process the functional groups or a precursor of the functional groups, are introduced downstream of the plasma, i.e. downstream of the plasma glow region. In contrast the use of a direct, in-glow technique has been found to be advantageous as it allows advantageous extra crosslinking of the polymer and functional groups during the polymerization step (e.g cross-linking of carboxylic acid containing polymers). Thus this single step deposition method allows high, maximum efficiency for heavy metal capture.

When the functional groups are part of a functional entity, for example a polymer, the polymeric functional entity is applied to a substrate on which the surface is to be laid by contacting the substrate with a functional entity precursor monomer in a plasma, in order to cause polymerisation of the monomer and deposition of the resultant polymeric functional entity onto the substrate.

The plasma process by which the chemically functionalized surface is prepared may be a conventional plasma (or plasmachemical) deposition processes. The plasma process is preferably carried out as a solvent-less process. The plasma process may be used to prepare a well-defined functionalized surface, e.g. in the form of a polymer film by deposition of a monomer (polymer precursor) onto a substrate, which causes the precursor molecules to polymerise as they are deposited. Such plasma-activated polymer deposition processes have been widely documented in the past—see for example Yasuda, H, “Plasma Polymerization”, Academic Press: New York, 1985, and Badyal, J P S, Chemistry in Britain37 (2001): 45-46.

The plasma process by which the chemically functionalized surface is prepared may be carried out in the gas phase, typically under sub-atmospheric conditions, or on a liquid monomer or monomer-carrying vehicle as described in WO-03/101621.

In one embodiment, the chemically functionalized surface is prepared using a pulsed exciting medium, i.e. a pulsed plasma. In a further embodiment, it is prepared using an atomised liquid spray plasma deposition process, in which, again, the plasma may be pulsed.

Pulsed plasmachemical deposition typically entails modulating an electrical discharge on the microsecond-millisecond timescale in the presence of a suitable monomer, thereby triggering monomer activation and reactive site generation at the substrate surface (via VUV irradiation, and/or ion and/or electron bombardment) during each short (typically microsecond) duty cycle on-period. This is followed by conventional polymerisation of the monomer during each relatively long (typically millisecond) off-period. Polymerisation can thus proceed in the absence of, or at least with reduced, UV-, ion-, or electron-induced damage.

Pulsed plasma deposition can result in polymeric layers which retain a high proportion of the original functional moieties, and thus in structurally well-defined coatings. The advantages of using (pulsed) plasma deposition, in order to deposit the functional groups or functional entity, can include the potential applicability of the technique to a wide range of substrate, e.g. surface, materials and geometries, with the resulting deposited layer conforming well to the underlying surface. The technique can provide a straightforward and effective method for providing a chemically functionalized surface, being a single step, solvent-less and substrate-independent process. The inherent reactive nature of the electrical discharge can ensure good adhesion to the substrate surface via free radical sites created at the interface during ignition of the exciting medium. Moreover during pulsed plasma deposition, the level of surface functionality can be tailored by adjusting the plasma duty cycle.

A polymer which has been applied to a substrate surface using plasma deposition will typically exhibit good adhesion to the substrate surface. The applied polymer will typically form as a uniform conformal coating over the entire area of the substrate which is exposed to the relevant monomer during the deposition process, regardless of substrate geometry or surface morphology. Such a polymer will also typically exhibit a high level of structural retention of the relevant monomer, particularly when the polymer has been deposited at relatively high flow rates and/or low average powers such as can be achieved using pulsed plasma deposition or atomised liquid spray plasma deposition.

Any suitable conditions may be employed for the preparation of the chemically functionalized surface, i.e. application of the functional groups or functional entity, depending on the nature of the groups or entity and of the type of surface needed and on the substrate.

Preparation of the surface is suitably carried out in the vapour phase.

In one embodiment the chemically functionalized surface is prepared by plasma deposition of a precursor of maleic anhydride in the vapour phase to form a layer of polymer having functional anhydride groups.

By way of example, and in particular when the functional entity is applied using a pulsed exciting medium and/or when the functional entity is a poly(anhydride) (more particularly a poly(maleic anhydride)), one or more of the following conditions may be used:
a. a pressure of from 0.01 mbar to 1 bar, for example from 0.01 or 0.1 mbar to 1 mbar or from 0.1 to 0.5 mbar, such as about 0.2 mbar.
b. a temperature of from 0 to 300° C., for example from 10 or 15 to 70° C. or from 15 to 30° C., such as room temperature (which may be from about 18 to 25° C., such as about 20° C.).
c. a power (or in the case of a pulsed exciting medium, a peak power) of from 1 to 500 W, for example from 1 to 20 W or from 1 or 10 W, such as about 5 W.
d. in the case of a pulsed exciting medium (for example a pulsed plasma), a duty cycle on-period of from 1 to 5,000 μs, for example from 1 to 500 or from 5 to 500 or from 5 to 100 μs or from 5 to 50 μs, such as about 20 μs.
e. in the case of a pulsed exciting medium (for example a pulsed plasma), a duty cycle off-period of from 1 to 100,000 μs, for example from 1 to 10,000 μs or from 1 to 3,000 μs, such as about 1200 μs.
f. in the case of a pulsed exciting medium (for example a pulsed plasma), a ratio of duty cycle on-period to off-period of from 0.0005 to 1.0, for example from 0.0005 to 0.1 or from 0.0005 to 0.02, such as about 0.0167.

In the case of a pulsed exciting medium such as a pulsed plasma, conditions (d) to (f) may be particularly preferred, more particularly conditions (d) and (f). Yet more particularly, it may be preferred to use a duty cycle on-period of from 1 to 100 or from 1 to 50 μs, and/or a ratio of duty cycle on-period to off-period of from 0.0005 to 0.02 such as about 0.0167.

In a preferred embodiment, the functional groups are or the functional entity is applied to a substrate using a pulsed plasma deposition process. A pulsed electrical discharge can result in structurally well-defined layers. Mechanistically, it entails the generation of active sites in the monomer phase and also at the growing film surface during the short duty cycle on-period (typically microseconds), followed by conventional polymerisation mechanisms proceeding throughout the relatively long (typically milliseconds) duty cycle off-period, in the absence of any UV-, ion-, or electron-induced damage. The inherent reactive nature of the electrical discharge ensures good adhesion to the underlying substrate surface via free radical sites created at the interface during ignition of the plasma.

Known examples of pulsed plasma deposited well-defined functional films include poly(glycidyl methacrylate), poly(bromoethyl-acrylate), poly(vinylaniline), poly(vinylbenzyl chloride), poly(allymlercaptan), poly(N-acryloylsarcosine methyl ester), poly(4-vinylpyridine) and poly(hydroxyethyl methacrylate).

According to a second aspect of the present invention there is provided a substrate for use in a method for heavy metal capture according to the first aspect of the present invention, which substrate is provided with a chemically functionalized surface prepared by a plasma process, the surface being provided with organic functional groups able to coordinate with and thereby capture a heavy metal.

The substrate may be made from any suitable material. It may be adapted in form or shape to suit the method of use. Suitable materials will be well known to the skilled person and include silicon materials and porous or non-porous, woven or non-woven materials, such as non-woven polypropylene cloth. The substrate may take the form of a membrane or filter, such as those used in ultrafiltration techniques formed from poly(sulfone)s.

The chemically functionalized surface of the substrate of the second aspect of the present invention and its preparation may be substantially as described above for the first aspect of the present invention.

The present invention is advantageous as it provides a method and substrate capable of a high degree of efficiency for the capture of heavy metal ions from aqueous solution (down to the low parts per billion range), a method and substrate that allows for the easy subsequent release of the removed heavy metal species and easy regeneration of the chemically functionalized surface for future reuse, e.g. regeneration can be accomplished by rinsing in weak acid solution.

A further advantage of the present invention is that it overcomes the problems associated with known methods of heavy metal capture. Previous materials and coatings employed to remove heavy metal ions, e.g. cadmium ions, from solution are reported to suffer from a lack of specificity or recyclability. In contrast, the chemically functionalized surfaces of the present invention, e.g. pulsed plasma deposited poly(maleic anhydride) nanocoatings, are specific to heavy metal ions and can be regenerated by washing in mild acid solutions. Due to the high density of functional groups that the surfaces of the present invention exhibit the methods of the present invention require less time in comparison to known methods in order to lower heavy metal ion concentrations in solution, such times may be cut by half. The amount of heavy metal capture is comparable with known methods such as the use of biopolymers, e.g chitosan removal, and is increased in comparison with other known methods such as biological and inorganic systems.

The chemically functionalized surfaces of the present invention, particularly those prepared using pulsed plasmachemical deposition, have many advantages for example, their method of preparation of the surfaces allows for the fabrication of high-density functional groups, e.g. high density of carboxylic acid groups, so that the surfaces are particularly adapted for use as capture and release coatings on substrates. As the surfaces are prepared from a single-step, conformal, solvent-less process, the methods and substrates of the present invention allow for low energy consumption of heavy metal extraction, which are also easily scalable to industrial practice.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, for example for the concentration of a component or a temperature, then a range of values defined by a combination of any of the upper limits with any of the lower limits may also be implied.

In this specification, references to properties such as solubilities, liquid phases and the like are—unless stated otherwise—to properties measured under ambient conditions, ie at atmospheric pressure and at a temperature of from 18 to 25° C., for example about 20° C.

The present invention will now be further described with reference to the following non-limiting examples and the accompanying figures, of which:

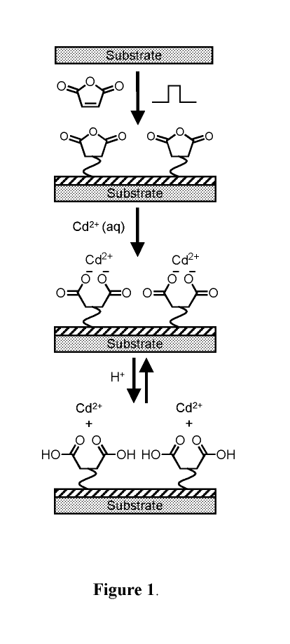

FIG. 1 shows schematically a method in accordance with the first aspect of the present invention;

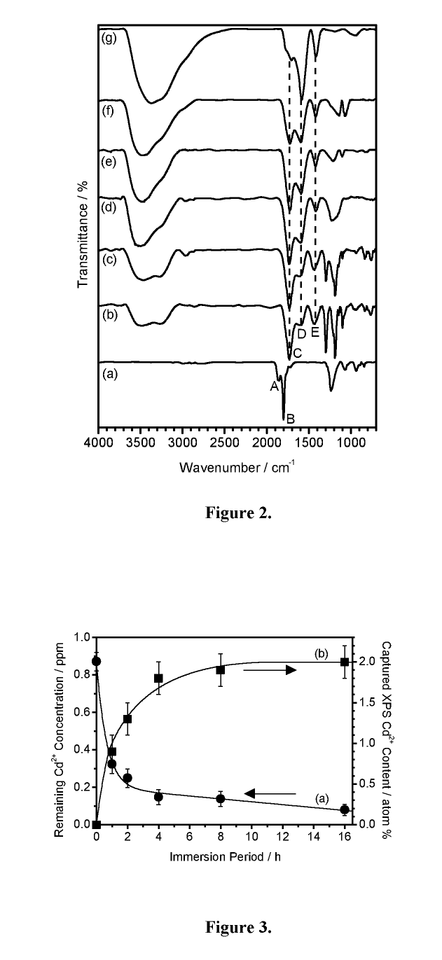

FIG. 2 shows FTIR spectra of the surface used and produced in Example 1 below; and

FIG. 3 shows a graph of heavy metal ion concentration against time of a heavy metal ion solution in contact with the surface used and produced in Example 1.

### DETAILED DESCRIPTION

The scheme shown in FIG. 1 illustrates a method of heavy metal ion capture in accordance with the present invention using a chemically functionalised surface provided with a nanolayer of functional groups, as is described in more detail below.

### EXAMPLE 1

In this example pulsed plasmachemical deposition of maleic anhydride precursor was used in order to produce nanocoatings containing a high density of carboxylic anhydride groups which subsequently can be used to capture cadmium ions from water, as illustrated in FIG. 1.

Preparation of the Chemically Activated Surface

The pulsed plasmachemical deposition entailed modulating an electrical discharge on the microsecond-millisecond timescale such that precursor vapour is activated at the substrate surface (via VUV irradiation, ion, or electron bombardment) during each microsecond on-period, followed by conventional polymerization of the precursor carbon-carbon double bond during each subsequent millisecond off-period. This led to polymeric coatings with high levels of structural retention. This single-step fabrication technique is straightforward and readily applicable to heavy metal ion capture and release from industrial wastewaters.

Pulsed plasmachemical depositions were typically carried out for 30 min to produce a film of 100 nm thickness on silicon wafer.

In more detail preparation was as follows:

Plasmachemical Deposition of Anhydride Layers

Plasmachemical deposition was carried out in an electrodeless cylindrical glass reactor (volume of 480 cm³, base pressure of 3×10⁻³ mbar, and with a leak rate better than 2×10⁻⁹ mol s⁻¹) surrounded by a copper coil (4 mm diameter, 10 turns), and enclosed in a Faraday cage. The chamber was pumped down using a 30 L min⁻¹ rotary pump attached to a liquid nitrogen cold trap, and a Pirani gauge monitored system pressure. Maleic anhydride briquettes (+99%, Aldrich Ltd., ground into a fine powder) were loaded into a sealable glass tube connected to the system followed by degassing through several freeze-pump-thaw cycles. The output impedance of a 13.56 MHz radio frequency (rf) power supply was matched to the partially ionized gas load via an L-C matching unit connected to the copper coil. Prior to each deposition, the reactor was scrubbed using detergent, rinsed in propan-2-ol, and dried in an oven. A silicon (100) wafer piece (Silicon Valley Microelectronics Inc.) was then inserted into the chamber and a continuous wave air plasma was run at 0.2 mbar pressure and 40 W power for 30 min in order to remove any remaining trace contaminants from the chamber walls. Maleic anhydride precursor vapour was allowed to purge the reactor for 5 min at a pressure of 0.2 mbar prior to electrical discharge ignition. An optimal duty cycle of 20 μs on-period and 1200 μs off-period in conjunction with a peak power of 5 W was employed for pulsed plasma deposition. Upon plasma extinction, the precursor vapour was allowed to continue to pass through the system for a further 3 min, and finally the chamber was evacuated back down to base pressure.

Film thicknesses were measured using a spectrophotometer (nkd-6000, Aquila Instruments Ltd.). This entailed acquisition of transmittance-reflectance curves (350-1000 nm wavelength range) for each sample and fitting to a Cauchy material model using a modified Levenberg-Marquardt algorithm. Film deposition rates were calculated to be 3±1 nm min⁻¹. Typical film thicknesses used for cadmium ion capture and release studies were 100 nm.

Heavy Metal Capture

Cadmium Capture and Release

Cadmium ion capture experiments entailed placing a piece of coated silicon wafer (1 cm² area) into 2 cm³ volume of a 850 parts per billion cadmium (II) chloride (Koche-Light Laboratories Ltd.) solution prepared using ultra high purity water (resistivity greater than 18 MΩ cm, organic content less than 1 ppb, Sartorius Arium 611), followed by gentle stirring. The sample substrate was then washed in ultra high purity water for 1 h. Cadmium ion release experiments entailed soaking the sample substrate in aqueous acetic acid (Fisher Scientific Ltd.) solution (pH=3.7) for 1 h in order to effect ion exchange between immobilized Cd²⁺ and H⁻ (aq).

Infrared spectra were acquired using a FTIR spectrometer (Perkin-Elmer Spectrum One) fitted with a liquid nitrogen cooled MCT detector operating at 4 cm⁻¹ resolution across the 700-4000 cm⁻¹ range. The instrument included a variable angle reflection-absorption accessory (Specac Ltd.) set to a grazing angle of 66° for silicon wafer substrates and adjusted for p-polarization.

The concentration of cadmium ions present in solution was measured by atomic absorption spectroscopy at a wavelength of 228.8 nm (Varian Spectra AA 220FS Atomic Absorption Spectrophotometer). Cadmium equilibration standards were prepared from a certified 1000 mg L⁻¹ stock solution (PlasmaCAL SCP Science).

Surface elemental compositions were determined by X-ray photoelectron spectroscopy (XPS) using a VG ESCALAB II electron spectrometer equipped with a non-monochromated Mg Kα X-ray source (1253.6 eV) and a concentric hemispherical analyser. Photoemitted electrons were collected at a take-off angle of 20° from the substrate normal, with electron detection in the constant analyser energy mode (CAE, pass energy=20 eV). Experimentally determined instrument sensitivity (multiplication) factors were taken as C(1s):O(1s):Cd(3d) equals 1.00:0.36:0.05. All binding energies were referenced to the C(1s) hydrocarbon peak at 285.0 eV. A linear background was subtracted from core level spectra and then fitted using Gaussian peak shapes with a constant full-width-half-maximum (fwhm).

Results

The following results were obtained when the coatings were subsequently exposed to aqueous solutions of cadmium (II) chloride.

As shown in FIG. 2 Fourier transform infrared spectra of the pulsed plasma deposited poly(maleic anhydride) nanocoatings show distinctive carboxylic anhydride symmetric and antisymmetric C═O stretches at 1850 cm⁻¹ and 1802 cm⁻¹ respectively (denoted A and B) in FIG. 2. The peak positions are consistent with a cyclic unconjugated system, which is indicative of the carbon-carbon double bond contained in the maleic anhydride molecule undergoing reaction during deposition (i.e. conventional polymerisation taking place). These anhydride absorbances disappear upon exposure to 870 ppb cadmium(II) chloride solution to be replaced by carboxylic acid antisymmetric C═O stretches (1730 cm⁻¹, denoted C), carboxylate antisymmetric C═O stretches (1591 cm⁻¹, denoted 10 D), and carboxylate symmetric C═O stretches (1420 cm⁻¹, denoted E). In addition there are carboxylic acid dimer and monomer C—O stretches at 1301 cm⁻¹ and 1184 cm⁻¹ respectively. These acid peaks correlate to the anhydride groups undergoing hydrolysis in the presence of water, whilst the carboxylate peaks correspond to ion exchange of Cd²⁺ for H. The carboxylate bands become stronger with increasing exposure to the cadmium ion solution. As an absolute reference point, the maximum signal intensity for the carboxylate features was measured using a 1 mol dm⁻³ 20 cadmium (II) chloride solution for 1 h exposure (which is shown for comparison). Subsequent rinsing of the coatings in aqueous acetic acid gave rise to the disappearance of the carboxylate peaks at 1591 cm⁻¹ and 1420 cm⁻¹ due to the release of cadmium ions, see FIG. 2.

As shown in FIG. 3 atomic absorption spectroscopy analysis of the cadmium (II) chloride solutions following immersion of the pulsed plasma deposited poly(maleic anhydride) substrates showed an exponential decrease of cadmium concentration versus length of exposure, see FIG. 3. It is estimated that 50% of the cadmium ions present in the solution can be absorbed within 40 min and this drops to below 80 ppb after 16 h of immersion.

X-ray photoelectron spectroscopy of the pulsed plasma deposited poly(maleic anhydride) nanolayers following removal from the cadmium (II) chloride solution and rinsing in high purity water showed a concurrent increase in the surface cadmium content with length of immersion time, see FIG. 3. This cadmium concentration reached a value of around 2 atom % after 8-16 h. For the case of soaking in a reference control solution (1 mol dm⁻³ cadmium (II) chloride solution for 1 h), the cadmium level was measured to be 4.7 atom %. This corresponds to a cadmium absorption capacity of 310 mg per gram of coating. Subsequent rinsing in acetic acid solution resulted in the complete disappearance of the cadmium XPS signal which is indicative of metal ion release/regeneration. These nanocoatings could be reused multiple times without observing any deterioration of cadmium ion capture and release performance.

Previous materials and coatings employed to remove cadmium ions from solution are reported to suffer from a lack of specificity or recyclability. In contrast, the current pulsed plasma deposited poly(maleic anhydride) nanocoatings are specific to heavy metal ions and can be regenerated by washing in mild acid solutions.

Zinc Capture and Release

Similar results were observed for zinc ions. The maximum weight of zinc capture per gram of coating reached 160 mg.

No absorption was recorded for non-toxic alkali or alkaline earth metals.

The observed time taken to lower the cadmium ion concentration in solution by half is around 40 min, which compares favourably with previous approaches, where the time can take around double. The maximum weight of cadmium capture per gram of coating is 310 mg, which is in the same range as biopolymers such as chitosan (100-500 mg g⁻¹),and far better than other biological and inorganic systems. The high capacity for these coatings to absorb cadmium ions in the form of metal carboxylate groups can be attributed to the high density of carboxylic acid groups present in the hydrated pulsed plasma deposited layers.

The outlined pulsed plasmachemical deposition approach offers many advantages for the fabrication of high-density carboxylic acid capture and release coatings, including single-step, conformal, solvent-less, and low energy consumption.

To scale these examples up to industrial practice would be easy. As an example an increase in effective surface area of the pulsed plasma deposited nanocoatings of the present examples is easily envisaged (due to the conformality of the vapour-phase plasma process), for instance by coating porous or high surface-area substrates (e.g. nonwoven polypropylene cloth) in combination with roll-to-roll processing.

1. A method of capturing heavy metal, comprising the step of bringing the heavy metal into contact with a chemically functionalized surface prepared by a plasma process, the surface being provided with organic functional groups able to coordinate with and thereby capture the heavy metal.

2. The method of claim 1, wherein the heavy metal is brought into contact with the chemically functionalized surface in the form of a heavy metal ion.

3. The method of claim 1, wherein the heavy metal is brought into contact with the chemically functionalized surface in an aqueous solution.

4. The method of claim 1, wherein the heavy metal is selected from the group consisting of cadmium, zinc, aluminium, arsenic, cobalt, chromium, copper, iron, mercury, manganese, molybdenum, nickel, lead, plutonium, tin, thallium, tungsten, thorium, uranium and vanadium.

5. The method of claim 4, wherein the heavy metal is selected from the group consisting of cadmium and zinc.

6. The method of claim 4, wherein the heavy metal is cadmium.

7. The method of claim 1, wherein the chemically functionalized surface is provided with organic functional groups able to form coordination bonds with the heavy metal via at least one of a sulphur or an oxygen atom.

8. The method of claim 1 comprising the further step of removing the heavy metal captured by the chemically functionalized surface.

9. The method of claim 8, wherein the removal of the captured heavy metal is effected by contacting the chemically functionalized surface with a reversing agent.

10. The method of claim 9, wherein the reversing agent is a weak acid, a strong acid, a weak alkali or a strong alkali.

11. The method of claim 1, wherein the chemically functionalized surface is provided with one or more functional groups or precursor to functional groups selected from the group consisting of hydroxyl, carboxylic acid, anhydride, epoxide, furfuryl, amine, cyano, halide, trifluoromethyl and thiol groups or groups that include or can be derived from alkenes, alkynes, alkyls, phosphines, hydrides and heteroaryl groups.

12. The method of claim 11, wherein the chemically functionalized surface is provided with active acyl groups or precursors to active acyl groups.

13. The method of claim 11, wherein the chemically functionalized surface is provided with acetic anhydride or maleic anhydride or a derivative thereof.

14. The method of claim 12, wherein the chemically functionalized surface is provided with (trifluoromethyl) maleic anhydride.

15. The method of claim 1, wherein the functional groups are part of a poly(anhydride) or derivatives thereof.

16. The method of claim 15, wherein the poly(anhydride) is formed from units of acetic anhydride or maleic anhydride and their derivatives or mixtures thereof.

17. The method of claim 14, wherein the poly(anhydride) is poly((trifluoromethyl)maleic anhydride) or poly(maleic anhydride-co-styrene).

18. The method of claim 1, wherein the chemically functionalized surface is provided with a monolayer, nanolayer or nanocoating of the functional groups.

19. The method of claim 1, wherein the chemically functionalized surface is prepared by pulsed plasma deposition.

20. A substrate for use in a method for capturing heavy metal, wherein the substrate is provided with a chemically functionalized surface prepared by a plasma process, and wherein the surface is provided with organic functional groups able to coordinate with and thereby capture a heavy metal.
